(19) United States
(12) Patent Application Publication
(10) Pub. No.: US 2024/0236813 A9
(43) Pub. Date: Jul. 11, 2024

(54) Network Node and Method for Sustaining Ultra-Reliable Communication in Wireless Communication Network

(71) Applicant: Telefonaktiebolaget LM Ericsson (publ), Stockholm (SE)

(72) Inventors: Bipin Balakrishnan, Kävlinge (SE); Fredrik Dahlgren, Lund (SE); Ashkan Kalantari, Malmö (SE); Saeed Bastani, Dalby (SE)

(21) Appl. No.: 18/546,667

(22) PCT Filed: Mar. 15, 2021
(86) PCT No.: PCT/EP2021/056508

§ 371 Date: Aug. 16, 2023

(51) Int. Cl. H04W 40/22; H04W 40/10; H04W 40/12; H04W 40/18; H04W 40/20

(52) U.S. Cl. CPC H04W 40/22; H04W 40/10; H04W 40/12; H04W 40/18; H04W 40/20

(57) ABSTRACT

A network node and method therein for ultra-reliable communication with a communication device in a wireless communications network are disclosed. The network node determines whether the communication with a second communication device is to be relayed via a relay node and determines that the first communication device is able to act as a relay node for the second communication device. The network node requests the first communication device to operate in a relay mode for relaying communications to the second communication device. The network node communicates with the second communication device over a relay link from the network node to the first communication device and from the first communication device to the second communication device.

### TECHNICAL FIELD

Embodiments herein relate to a network node and methods therein for sustaining an ultra-reliable communication. In particular, they relate to sustaining an ultra-reliable communication for a communication device in a wireless communication network by dynamic relaying.

### BACKGROUND

Wireless communication networks, such as Global System for Mobile Communications (GSM) networks, Wideband Code Division Multiple Access (WCDMA) or High Speed Packet Access (HSPA) networks, 3G Long Term Evolution (LTE) networks, Worldwide interoperability for Microwave Access (Wimax) network, Wireless Local Area Network (WLAN/Wi-Fi), LTE advanced or Fourth Generation (4G) networks, and Fifth Generation (5G) New Radio (NR) networks, usually cover a geographical area which is divided into cell areas. Each cell area is served by a base station, which may also be referred as a Network (NW) node, eNodeB (eNB), gNodeB, an access node etc. A wireless communication network may include a number of cells that can support communications for a number of wireless communication devices or User Equipment (UE). Each cell or NW node may use certain carrier frequencies and cover certain system bandwidth. The NW node serves a wireless communication device via a wireless communication link, which may also be referred to as a radio channel or communication channel.

Wireless communication in higher frequency bands such as Frequency Range 2 (FR2) including frequency bands from 24.25 GHz to 52.6 GHz, are sensitive to obstacles that might limit the radio channel and cause disruptions in the communication between a UE and a base station. Ultra-Reliable Low-Latency Communication (URLLC) applies to applications demanding real-time services that cannot be disrupted. Device-2-device (D2D) enables communication directly between UEs. D2D-based relay has been proposed to enable multi-hop, e.g. from UE A to UE B and from UE B to base station (UEA-UEB-Base station), communication to overcome temporary blocking of the radio channel between UE A and the base station.

Most of the existing solutions involving relays are to improve performance of a communication network and often based on fixed location relays. The ones that cover dynamic mobile relays, such as in R. Ibrahim, et. al., “A Dynamic and Incentive Policy for Selecting D2D Mobile Relays”, Computing Research Repository (CoRR) in arXiv, 2019, are focusing on the trade-offs between performance enhancement, e.g. throughput, reliability, coverage, versus costs e.g. power budget, transmission power, and not prioritizing the requirement of maintaining a sustained communication link to support the ultra-reliability (UR) aspects of URLLC applications.

### SUMMARY

As part of developing embodiments herein a problem was identified and will first be discussed.

The pre-art solutions do not consider reliability as packet success rate within a bounded latency, which is the case for applications that belong to URLLC use-case type. When using dynamic mobile relays, devices are mobile, and the circumstances may change. For example, a mobile relay may enter into a non-coverage region of a network node along with a device it is serving, usually referred to as a client device, then the communication between the mobile relay and the network node may be disrupted, and the communication between the client device and the network node via the mobile relay is also disrupted. The prior art, therefore, do not provide a reliable solution for scenarios when devices are moving, and the circumstances change.

It is therefore an object of embodiments herein to provide an improved technique for sustaining an ultra-reliable communication in a wireless communication network for devices requiring a high communication link quality.

According to a first aspect of embodiments herein, the object is achieved by a method performed in a network node for communication with a communication device in a wireless communication network. The wireless communication network comprises the network node providing a coverage area and at least two communication devices.

The network node communicates with a first communication device over a first communication link between the network node and the first communication device.

The network node communicates with a second communication device over a second communication link between the network node and the second communication device.

The network node determines whether the communication with the second communication device is to be relayed via a relay node and determines that the first communication device is able to act as a relay node for the second communication device.

The network node requests the first communication device to operate in a relay mode for relaying communications to the second communication device if it is determined that the communication with the second communication device is to be relayed via a relay node.

The network node communicates with the second communication device over a relay link from the network node to the first communication device and from the first communication device to the second communication device.

According to some embodiments herein, the network node may create a group of candidate relay nodes comprising one or more communication devices which are in the coverage area of the network node and have capability and willingness to support relay node functionality.

The network node may assess prioritizations among the group of the candidate relay nodes. The network node may determine the first communication device as a relay node out of the group of the candidate relay nodes based on the assessed prioritizations. The network node may evaluate characteristics of the wireless communication devices which are in the group of candidate relay nodes to assess the prioritizations. The characteristics of the wireless communication devices may include e.g. communication channel quality of the communication devices to the network node, capabilities of the communication devices; battery status of the communication devices; ongoing communication activities of the communication devices; projected movements of the communication devices; time schedule slacks of the communication devices, serving time thresholds of the communication devices indicating during which they can serve as a relay node, etc.

The network node may check if re-appointing a third communication device as a relay node for the second communication device is needed based on any one or a combination of a channel quality of the first communication link, a trajectory of the first communication device.

The network node may update the group of candidate relay nodes or re-create a group of candidate relay nodes by keeping track the characteristics of the different communication devices.

The network node may control the movement and/or the velocity of the relay node such that the relay node positions itself in a location to guarantee that the quality of the relay link meets a required threshold.

The network node may appoint a number of communication devices placed at several fixed locations as dedicated relay nodes (DRNs). The network node may also control communication devices that are mobile but temporarily not used to be positioned at suitable places and appoint them to be acting as DRNs.

According to a second aspect of embodiments herein, the object is achieved by a network node for communication with a communication device in a wireless communication network. The network node is configured to perform the method according to the first aspect of embodiments herein described above.

In other words, according to embodiments herein, a network node and method therein are provided for managing relay nodes that also address the dynamics of moving devices, which they serve. The network node requests a communication device to operate in a relay mode for one or more other communication devices whose communication to the network node has higher priority and the quality of the communication link to the network node does not or will not meet a required threshold. A group of candidate relay nodes may be created which comprises one or more communication devices which are in the coverage area of the network node and have capability and willingness to support relay node functionality. The network node appoints a communication device as a relay node out of the group of the candidate relay nodes based on the assessed prioritizations. The appointed communication device supports the relay node functionality to ensure a sustained communication link to one or more other communication devices. The relay node functionality involves signalling to the network node and to each other, such as to achieve efficient handover so that there is only a max of 2 relay nodes between a communication device and a network node and after handover period there is only one relay link in addition to the direct link to the network node, which may be partially or fully blocked.

One of the principles to secure ultra-reliable communication according to embodiments herein is that a communication device which is in a coverage area of a network node is appointed as a relay node to maintain the communication link for a client device it is serving, when the client device is moving into and out of the coverage area. In order to secure that the client device it is serving always has a coverage, the mobility of the communication device acting as a relay node may be restricted and controllable. In other words, the communication device acting as a relay node may position itself in a location, or temporarily restrict its further movements so that it can provide a sustained communication link to the communication device that needs sustained communication link. The communication device acting as a relay node thus may prioritize, at least temporarily, the relay function over its own normal communication device functionality. Further handover between relay nodes in the coverage region may be performed to secure ultra-reliable communication.

The embodiments herein ensure communication devices requiring ultra-reliable communication (URC) to support use-cases involving industrial fleet driving, Automated guided vehicle (AGV) etc., are in coverage and have always a reliable communication link in such an environment where the communication devices are mobile.

The embodiments herein provide a consolidating method handling dynamically appointed relay nodes as well as more permanently appointed relay nodes and dedicated relay nodes.

The embodiments herein minimize power and resource overhead for reliability enhancement using a limited number of relay nodes, for example 1 or at most 2 relay nodes dependent on scenario and impact on latency. Latency may also be reduced by using relay node, for example, if a client device experiences too much packet loss and hence needs retransmissions due to obstruction which leads to increased latency experienced per packet, then using relay node may reduce latency or control upper bound latency.

Therefore, the embodiments herein provide an improved method and apparatus for sustaining an ultra-reliable communication for critical applications that fall into URLLC use-case type.

### BRIEF DESCRIPTION OF THE DRAWINGS

Examples of embodiments herein are described in more detail with reference to attached drawings in which:

FIG. 1 is a schematic block diagram illustrating an example embodiment of a wireless communication network in which embodiments herein may be implemented;

FIG. 2 is a flowchart depicting one embodiment of a method in a network node according to embodiments herein;

FIG. 3 is an example signalling chart according to embodiments herein;

FIG. 4 is a schematic block diagram illustrating a relay handover scenario for a client device;

FIG. 5 is a schematic block diagram illustrating a system with dedicated relay nodes according to embodiments herein; and

FIG. 6 is a schematic block diagram illustrating an example embodiment of a network node.

### DETAILED DESCRIPTION

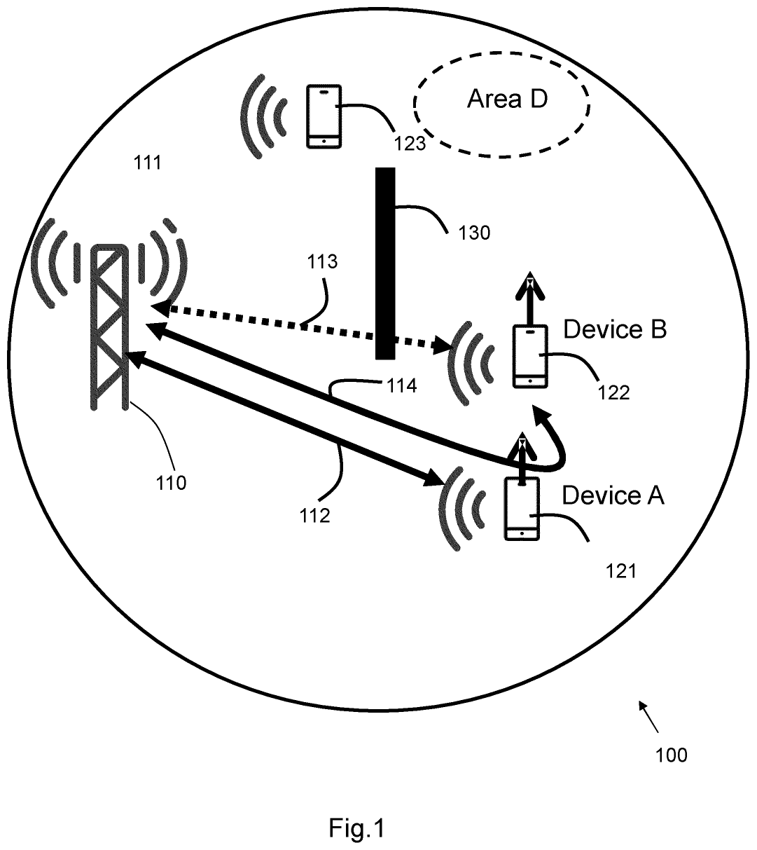

FIG. 1 illustrates an example scenario in a wireless communication network 100, where a communication link between a mobile device and a network node may be blocked. The wireless communication network 100 may be any wireless system or cellular network, such as a LTE network, any 3GPP cellular network, Wimax network, WLAN/Wi-Fi, an LTE advanced or 4G network, a 5G or NR network etc.

The wireless communication network 100 comprises a plurality of network nodes whereof a network node 110 has a coverage area, indicated by a cell 111 is depicted in FIG. 1. The network node 110 is a network access node which may be a base station (BS), for example, an eNB, gNB, eNodeB, gNodeB, or a Home NodeB, or a Home eNodeB or a Home gNodeB. For the sake of easier understanding by the reader, the term “cell” has been used above. However, spatial division between operation areas of a network node may be based on other entities, such as sectors, beams, etc. Sectors are statically defined directions from an antenna of the network node and beams are dynamically defined directions from an antenna of the network node. Thus, for any disclosure herein where the term “cell” is used, the demonstrated principles are equally feasible for sectors, beams, etc., unless explicitly or implicitly expressed otherwise.

Multiple communication devices operate in the wireless communication network 100, whereof a first communication device 121, Device A, a second communication device 122, Device B, and a third communication device 123, are depicted in FIG. 1. The communication device 121, 122, 123 may be any type of device with wireless communication capabilities, such as a UE, modem, an Internet of Things (IoT) device, an MTC device, a mobile wireless terminal or a mobile phone, a smartphone, or any other radio network unit capable to communicate over a radio link in a wireless communication network.

As shown in FIG. 1, the two communication devices, the first and second communication devices, Device A and Device B, are moving in the directions indicated by a black line with single arrow. Device B requires ultra-reliable communication with the network node 110, and at radio frequencies e.g. FR2, which can be obstructed by walls or obstacles indicated by a black bar 130. Device A has a communication link with the network node 110, indicated by an arrow line 112, and may be a potential relay node for Device B via Device to Device (D2D) communication. As illustrated in the FIG. 1, Device B has moved behind the wall 130, which may be referred to as a radio shadow region, so its direct link to the network node 110, indicated by a dashed arrow line 113, is no longer reliable or even useful, so it now communicates via the relay link through Device A, indicated by an arrow line 114.

The proposed solutions according to embodiments herein handle the dynamics of such a network when devices are moving, and the scenario is dynamically changing. As the second communication device 122, Device B, is now dependent on Device A for its communication until it reaches an area where it can restore its direct link to the network node 110, the network node 110 may direct the first communication device 121, Device A, to not yet move behind the wall 130 so it may also lose its connection until Device B has reached an area where reconnection is achieved. Hence, the movements of the first communication device 121, Device A, may be restricted so that it can continue to support Device B or even proactive in that it moves in a way that it can continuously support Device B until either Device B has good coverage or another relay node takes over.

A relay node is a node that is capable and willing to act as a relay to enable a communication between the network node and another device via the relay node. In FIG. 1, the first communication device 121, Device A, is an appointed relay node for Device B, and the critical communication traffic is now going via the first communication device 121, Device A, as long as Device B does not have a direct link to the network node 110. When Device B proceeds into “Area D” indicated by dotted oval in the figure, the traffic of Device B will be handed over to a direct link between it and the network node 110.

The principle of embodiments herein for an ultra-reliable communication is based on the following concepts:
The network node can restrict the movement of an appointed relay node, e.g. Device A, for the client device, e.g. Device B, to guarantee non-disrupted communication. Thus, the appointed relay node positions itself in a location so as to guarantee the sustained communication link to the client device.
Dynamically enabling a communication device as relay nodes depending on their real-time demands, e.g. ability to have its mobility restricted, besides their position, capabilities, and others. Once the relay node functionality is enabled, this relaying function takes precedence over the normal function of the appointed relay node.

A method performed in a network node for sustaining an ultra-reliable communication is developed according to above concepts and will be described in the following.

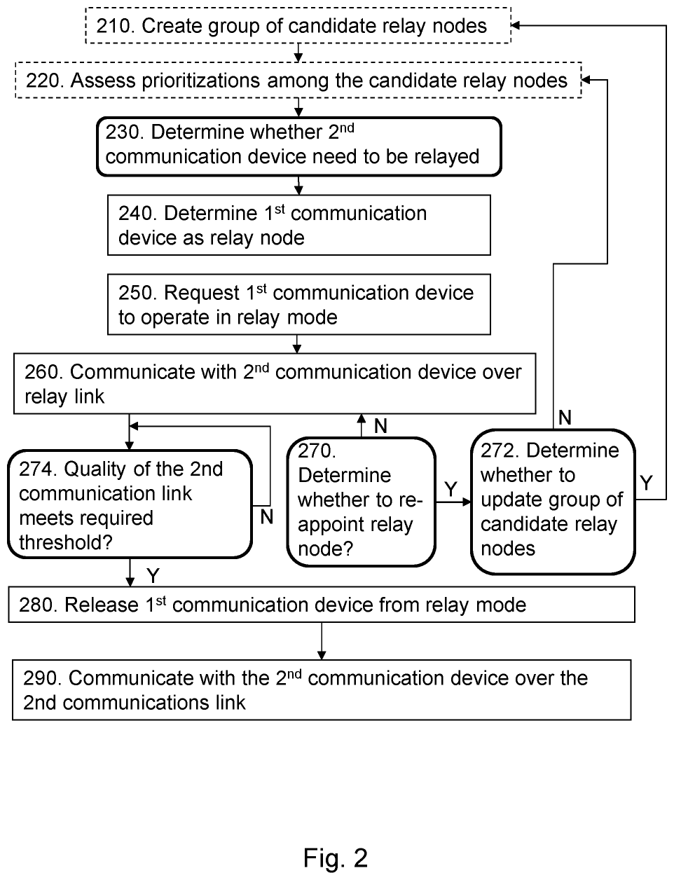

According to embodiments herein, a method performed in a network node for communication with a communication device in a wireless communications network will now be described with reference to FIG. 2. The wireless communication network 100 comprises the network node 110 and at least two communication devices 121, 122, 123. The network node 110 provides a coverage area in which the wireless communication devices are served via communication links. The network node 110 may be any of a base station (BS), an eNB, gNB, eNodeB, gNodeB, a Home NodeB, a Home eNodeB, a Home gNodeB, a Relay Node Selection entity or a dedicated application unit or a central entity in the Core Network. The network node 110 communicates with a first communication device 121 over a first communication link between the network node 110 and the first communication device 121. The network node 110 communicates with a second communication device 122 over a second communication link between the network node 110 and the second communication device 122. The method comprises the following actions which actions may be performed in any suitable order.

Action 210

According to some embodiments herein, the network node 110 may create a group of candidate relay nodes comprising one or more communication devices 121, 122, 123 which are in the coverage area of the network node 110 and have capability and willingness to support relay node functionality.

The group of candidate relay nodes (RNs) may be created based on Proximity Services (ProSe). It is assumed that each of the communication devices 121, 122, 123 is able to accept a request from the network node 110 to enter into a relay mode operation, i.e. turn on the relay function in them to function as a relay. The capability and willingness to support relay node functionality may be indicated when the wireless communication devices 121, 122, 123 sign up to the ProSe.

Alternatively, the group of candidate relay nodes may be created based on network instruction, device discovery beacon to these devices identified in ProSe only and analysis of the report by the client device. For example, the network node creates the group of the candidate relay nodes based on the ProSe device discovery procedure in which a communication device and a client device are instructed to exchange device discovery beacon. As a part of this device discovery procedure, both the communication device under consideration for relay and the client device send the measurement report to the network node, which may then assign the communication device as a relay node to the client device if the link quality measurements are satisfactory.

Action 220

According to some embodiments herein, the network node 110 may assess prioritizations among the group of the candidate relay nodes. The prioritization may be assessed by evaluating characteristics of the communication devices 121, 122,123 which are in the group of candidate relay nodes. The characteristics of the communication devices 121, 122,123 may be any one or a combination of the following:
a) communication channel qualities of the communication devices 121, 122,123 to the network node 110.
b) capabilities of the communication devices 121, 122,123. For example, ability to act as relay, ability to prioritize relay operation over its normal operation, frequency bands supported, multi-input-multi-output (MIMO) support, ability to support relaying type: amplify-and-forward, decode-and-forward, compress-and-forward etc.
c) battery status of the communication devices 121, 122,123.
d) ongoing communication activities of the communication devices 121, 122,123.

In addition to above, the real-time status with respect to its own mobility of the communication devices 121, 122,123 may also be taken into consideration, for examples:
e) projected movements of the communication devices 121, 122,123. For example, the projected movement or path of the communication devices 121, 122,123 may be estimated similarly as the client device and also the timeframe that the communication devices 121, 122,123 may or will be in a radio shadow region where the communication link to the network node 110 maybe lost, may be estimated.
f) time schedule slacks of the communication devices 121, 122,123. For example, the possibility to delay the communication devices 121, 122,123 or adapt its path to secure its relay functionality may be evaluated.
g) serving time thresholds of the communication devices 121, 122,123 indicating during which they can serve as a relay node. For example, the candidate relay nodes may have limited tolerance to waiting or prolonging their normal trajectory for the sake of serving the client device. Thus, in one embodiment, the candidate relay node, e.g. the communication devices 121, 122,123, may indicates a serving time threshold during which it can serve as a relay. During this time interval, the candidate relay node commits to maintain a non-obstructed path with the network node unless such a decision cannot be controlled by the relay node due to external factors such as obstruction by other elements in the environment. The relay node selection process may take into consideration the indicated serving time thresholds for scheduling and prioritization of candidate relay nodes.

Action 230

The network node 110 determines whether the communication with the second communication device 122 is to be relayed via a relay node.

According to some embodiments herein, when a device needs ultra reliable communication, it may send a request to a network node to indicate its requirement. When the network node 110 receives a request from a wireless communication device, e.g. the second communication device 122, indicating a requirement on a high communication link quality between the second communication device 122 and the network node 110, the network node 110 determines whether the quality of the second communication link meets a required threshold. If it is determined that the quality of the second communication link does not or will not meet the required threshold, e.g. as shown in FIG. 1, Device B will move to the radio shadow region behind the wall 130 and its direct link to the network node 110 will not meet the required quality, then the network node 110 determines that the communication with the second communication device 122 is to be relayed via a relay node.

According to some embodiments herein, when a device has a declining battery level and it needs a significant amount of transmit power, it may be beneficial to route its communication to the network node via a relay node. Transmitting and receiving signals via a relay node which is closer to this device than the network node 110 does may save the power of this device since transmitting power and requirements on receiver's performance may be reduced. This device may send a request to a network node to indicate this if it wants to reduce its power consumption. Therefore, according to some embodiments herein, the network node 110 may receive a request from a wireless communication device, e.g. the second communication device 122, indicating that it has a declining battery level, the network node 110 then determine that the communication with the second communication device 122 is to be relayed via a relay node.

Action 240

The network node 110 determines that the first communication device 121 is able to act as a relay node for the second communication device 122.

The network node 110 may determine the first communication device 121 as a relay node out of the group of candidate relay nodes based on the assessed prioritizations.

For example, the first communication device 121 has a higher priority to be selected as a relay node based on the characteristics a)-g) listed above and will be secured to be available if a client device, i.e. the second communication device 122, will lose its connection to the network node 110.

In some embodiments, there are mechanisms to predict at which positions a client device is likely to lose its connection. The appointment of a relay node that then gets its movement potentially restricted is limited to such situations.

Action 250

The network node 110 requests the first communication device 121 to operate in a relay mode for relaying communications to the second communication device 122 if it is determined that the communication with the second communication device 122 is to be relayed via a relay node.

The network node may send a request to the first communication device 121 to indicate which device that the first communication device 121 is to be paired with and the first communication device 121 then enters to the relay mode operation.

When the first communication device 121 operates in the relay mode, the network node 110 may control the movement of the relay node, e.g. the first communication device 121, such that the relay node positions itself in a location to guarantee that the quality of the relay link meets a required threshold. The movement of the first communication device 121 may be controlled by measuring the quality of the first communication link when the first communication device 121 is moving until the first communication device 121 moves to a location where the quality of the relay link meets the required threshold. This control procedure may repeat during the communication if required to guarantee the quality of the relay link fulfills a required threshold since the relay link may get blocked.

The network node 110 may predict at which positions the second communication device 122 is likely to lose its connection and controlling the movement of the relay node based on the prediction.

The network node 110 may regulate the velocity of the relay node to avoid entering an area where the communication channel quality to the network node 110 does not or will not meet a required threshold.

The network node 110 may schedule the relay node so that the communications of the second communication device 122 is prioritized over the communications of the relay node. For example, the resource scheduling may be done in such a way that the network node may provide resources so that the communication needs to relay to the second device is carried out first. Then resources may be scheduled for the communication in normal operation mode of the relay node and only if these communications do not disturb the communication of the second communication device 122.

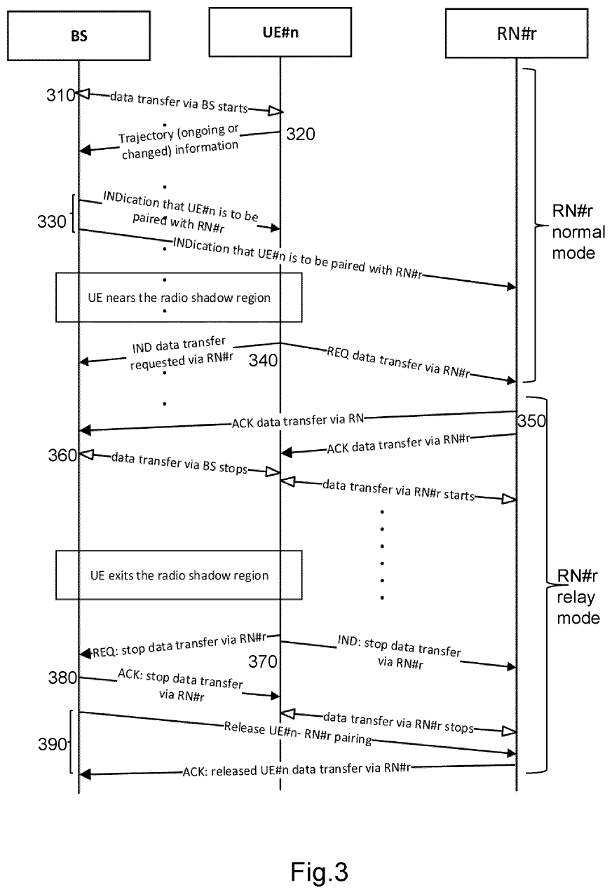

FIG. 3 is a signalling chart illustrating exemplary steps which may be implemented for the signalling between the network node 110 shown as a base station (BS), the first communication device 121 shown as a relay node (RN #r) and the second communication device 122 shown as a client device (UE #n), to handle communication between the network node 110, the first communication device 121 and the second communication device 122, for appointing and controlling relay nodes and handover traffics e.g. data transfer, between the direct link and relay link.

Step 310: Data transfer starts over the direct link between the network node BS and the client device UE #n.

Step 320: The client device UE #n sends ongoing or changed trajectory information to the network node BS.

Step 330: The network node BS sends an indication to the client device UE #n to indicate that the client device UE #n is to be paired with the relay node RN #r. The network node BS also sends an indication to the relay node RN #r to indicate that the client device UE #n is to be paired with the relay node RN #r. The network node BS allocates resources for the UE #n to contact RN #r.

Step 340: When the client device UE #n nears a radio shadow region, it sends an indication to the network node BS to request data transfer via the relay node RN #r. The client device UE #n also sends a request to the relay node RN #r to request dada transfer via the relay node RN #r.

Step 350: The relay node RN #r sends an ACK message to the network node BS and to the client device UE #n to indicate that the data transfer request via relay is acknowledged. The RN #r enters into a relay mode operation, i.e. a “restricted mode” which prioritizing relay operation over its data transmission in normal mode.

Step 360: The network node BS allocates resources for the client device UE #n to carry out data transmission via RN #r. Data transfer via the network node BS stops and data transfer via the relay node RN #r starts.

Step 370: When the client device UE #n exits the current radio shadow region and is sufficiently distant from the next radio shadow region, it requests to stop data transfer via the relay node as the network node BS needs to release the resources. The client device UE #n sends a request to the network node BS to stop data transfer via the relay node RN #r and sends an indication to the relay node RN #r to stop data transfer via the relay node RN #r.

Step 380: The network node BS sends an ACK message to the client device UE #n to indicate that the request to stop data transfer via the relay node is acknowledged.

In a scenario where the client device UE #n may not know if the next radio shadow region is nearby, but the network node BS knows, although the client device UE #n sends a request to stop data transfer via the relay node, the network node BS may not send an ACK message but may then maintain the existing relay node or request a new relay node. The client device UE #n is released from the communication via the relay node only when there is a possibility of continued connectivity via its direct communication link to the network node BS.

Step 390: The network node BS sends a request to the relay node RN #r to relase UE #n and RN #r pairing and the relay node sends an ACK message to the network node BS to confirm that the UE #n data transfer via RN #r is released.

This signalling chart may be used for trajectory signalling of the client device and shows how the network node BS may indicate the relay nodes in that trajectory and when those relay nodes are to be contacted via the second communication link, i.e. the sidelink between the two devices via e.g. PC5 interface.

As the client device UE #n nears the position of the relay node RN #r, it sends control signalling to the relay node and which in turn notifies the network node BS or a central entity so that the network node BS can switch the traffic and the device that acts as the relay node takes the relay function.

It should be noted that in FIG. 3, although it is shown that the network node BS pairs the RN #r and UE #n, it is UE #n's decision WHEN it should initiate the data transfer. Therefore, the UE #n sends a request (REQ) data transfer message to RN #r to indicate this. Secondly the network node BS needs to adjust the resource allocation. Therefore, UE #n sends also an indication (IND) that data transfer is requested via RN #r, which also notifies the network node BS when UE #n has initiated the request. So this acts similar as an ACK for the initial pairing of RN #r & UE #n.

According to some embodiments herein, the client device UE #n nearing a radio shadow may be determined by the network node BS based on other devices' measurements in that region, historical data, location, time of arrival, etc. The exiting of the client device UE #n from the radio shadow may also be determined by the network node BS based on other devices's measurements in the region and/or historical data.

Alternatively, the UE #n may continuously measure the received signal strength from the BS to determine if it is back in coverage. In addition, to avoid false indication that the UE #n has moved out of the radio shadow, UE #n could filter out small regions of spotty coverage to ensure that the signal strength is consistent for some pre-defined time period. Here, UE #n could use the synchronization signal block (SS block), which consists of Primary Synchronization Signal (PSS), Secondary Synchronization Signal (SSS), and the physical broadcast channel to check if it has moved out of the radio shadow. When the network node BS uses beamforming, it sweeps through its beams and transmits SS block through each beam, which is referred to as SS burst set. The UE #n listens for each SS block and if it can decode it, it responds to the BS with the time index of the decoded SS block to indicate the best transmitting beam of the BS.

The network node BS indicates the location of the relay node RN #r to the client device UE #n so that it can know when it reaches or nears that RN #r and then be able to address it with the relay node specific address, e.g. D2D ID/address, that was also passed to the UE #n during the “UE #n pairing with RN #r” message shown in FIG. 3.

Action 260

The network node 110 communicates with the second communication device 122 over a relay link from the network node 110 to the first communication device 121 and from the first communication device 121 to the second communication device 122. That is when the quality of the second communication link between the network node 110 and the second communication device 122 becomes too bad, the second communication device 122 will hand over its traffic to the relay link. This remains until there is again a robust direct channel to the network node 110, and the quality of the second communication link becomes good again.

In some embodiments, the second communication device 122 will start using the relay link as a dual-connectivity link in order to have resources for that link secured. Then, the latency of moving critical traffic into that relay link is minimal. It might also start moving the most critical traffic on that relay link. Therefore, according to some embodiments herein, the network node 110 may send the communications to the second communication device 122 over the second communication link in addition to over the relay link. According to some embodiments herein, the network node 110 may send the most critical communications to the second communication device 122 over the relay link.

According to embodiments herein, appointing relay node are handled dynamically to take into account scenarios when devices are moving and the circumstances change. If the connection to a relay node is bad or if the relay node is about to enter a radio shadow and its speed cannot be controlled, then the network node 110 may appoint another communication device as the relay node. This handover may be done based on the channel quality deterioration from the current relay node and/or the current relay node's trajectory is towards a radio shadow region. In some embodiments, the application's packet transmission periodicity may be used to understand if the current relay node will be in a strong coverage region in time for which the transmission is scheduled for the client communication device.

Therefore, according to embodiments herein, the method may further comprise the following action:

Action 270

The network node 110 may check if determining a third communication device 123 as a relay node for the second communication device 122 is needed based on a channel quality of the first communication link and/or a trajectory of the first communication device 121.

According to some embodiments herein, the third communication device 123 may be selected from the group of the candidate relay nodes based on recent channel quality indications of the candidate relay nodes, trajectory co-related with radio shadow regions in the common path of the second communication device 122 and the candidate relay nodes.

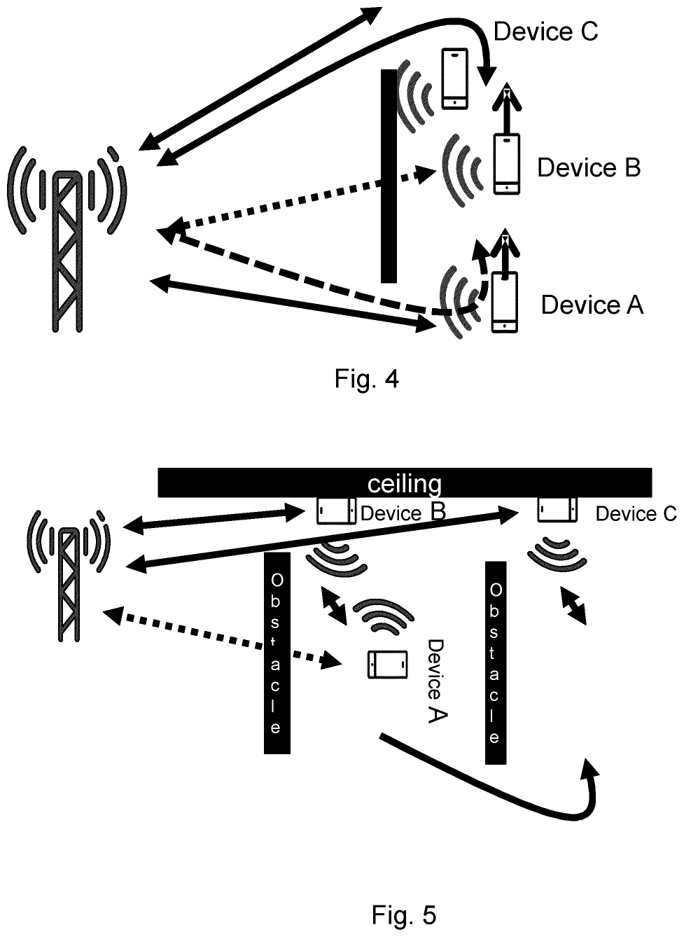

For example, as illustrated in FIG. 4, Device A being the current relay node signals that it cannot remain as a relay node. Since Device C, one of the communication devices in the group of candidate relay nodes, is well positioned and is not mobile, then it is being selected as the new relay node. The relay of Device B, i.e. the client device, is handed over from Device A to Device C.

Action 272

According to some embodiments herein, the network node 110 may determine whether to update group of candidate relay nodes by keeping track the characteristics of the communication devices 121, 122, 123. For example, some communication devices may no longer have capability to act as a relay node or some new communication devices may have entered the coverage area of the network node and indicate the willing to act as a relay node. In this case, the network node 110 may update the group of candidate relay nodes or re-create a group of candidate relay nodes.

According to embodiments herein, enabling and disabling of the relay link via the relay node is also dynamically handled.

As discussed above, the dynamic enabling of the connection link to a client device via a relay node may be based on channel quality. If there is a deterioration in the channel quality between the client device and the network node, this should be evident from the Channel Quality Indicator (CQI) or packet re-transmissions for other applications that needn't be URLLC, then the relay link is enabled. In some embodiments, the trajectory of the client device towards a radio shadow region may be also used to predict a poor radio link quality in the near future.

The dynamic disabling of the connection link to the client device via a relay node may be based on that the application requirement doesn't exist anymore or channel quality returns to good along with the battery power improvement. Therefore, the method may further comprise the following action:

Action 274

The network node 110 determines whether the quality of the second communication link meets a required threshold. For example, as shown in FIG. 1, the second communication device 122, Device B, has moved out of the radio shadow region and moved into the coverage area where the second communication device 122 can get a re-connection to the network node 110. In this case, the network node 110 determines that the quality of the second communication link meets a required threshold.

The area of re-connection may be predicted based on the history of previous connections. Furthermore, the knowledge that the second communication device 122 will likely lose its direct channel to the network node 110 as it comes behind the wall may also be predicted based on historical channel or beam data. In yet other embodiments, the predictions that a mobile device is approaching an area of poor radio conditions as well as when it is likely to regain connection may be predicted by machine learning techniques, and might be trained with data such as history of the Channel Quality Indicator (CQI) of prior devices in that area as well as paths combined with other dynamics of the environment such as number of devices in that vicinity, movement of obstacles, etc. The exact algorithms and neural network designs of such a machine learning solution is beyond the scope of this application.

According to embodiments herein, if it is determined that the quality of the second communication link meets a required threshold, the method further comprise the following actions:

Action 280

The network node 110 sends a request to the first communication device 121 to release from the relay mode if it is determined that the quality of the second communication link meets a required threshold.

Action 290

The network node 110 communicates with the second communication device 122 over the second communication link when the quality of the second communication link meets a required threshold.

According to embodiments herein, there are different types of schemes for dynamic relaying for sustaining ultra-reliable communication:
a) Dynamically deploying communication device as relay nodes with restrictions.
b) Appointing dedicated relay nodes (DRNs);
c) Combinations of a) and b).

The scheme a) is the basic scheme as described above. An appointed relay node will have its mobility affected to support the client device until either the client device can restore its direct link, or another candidate relay node takes over as the relay node. This becomes a real-time system in the following aspect, whereas the relay node will support the client device to move to its target position with reliable communication, it might be delayed and then risk its own mobility if that is time critical. Therefore, there may be a scheduling function implemented to consider the time criticality of the different communication devices as well as their priority. The ambition is to secure the real-time criticality of the highest prioritized tasks.

For the scheme b), as illustrated in FIG. 5, there are dedicated relay nodes, Device B, Device C, that are placed to support areas where devices typically have connection problems, e.g. close to walls or huge machinery. These dedicated nodes may be ordinary communication devices supporting the basic mechanisms as described above. These dedicated nodes may be appointed as relay nodes for client devices, e.g. Device A, since they indicate their support as such nodes, and they have no own real-time tasks to comply to.

Therefore, according to some embodiments herein, the wireless communication network 100 may further comprise a number of communication devices placed at several fixed locations, and the network node may appoint them as dedicated relay nodes.

This mechanism suited for an indoor environment e.g. factory where there are more moving metallic parts or obstacles that can create blockage or radio shadow due to either there is a periodic moving part putting a stationary device in radio shadow or a mobile device that goes into a radio shadow region.

In a factory, a number of such dedicated relay nodes can be placed so they can support the key areas where time-critical URC devices typically would risk losing their connection or have temporary disruptions impacting their critical communication.

The scheme c) is a combined system. A system according to the generic framework of a) and b) can consist of a number of DRNs as well as using dynamically deployed communication devices as relay nodes. Typically, in such a system, a few dedicated nodes may be placed in areas where there are difficult to find dynamic relay nodes, e.g. if there is few communication devices in that area, or if it is difficult to meet all client devices' real-time demands with only dynamically deployed relay nodes.

Since these DRNs may behave as any communication devices in this system, but always available as relay nodes, the system may be gradually extended with additional DRNs without having to change the basic functionality of the other communication devices. Hence, it becomes a scalable system, easily to extend. Furthermore, mobile communication devices that are temporarily not used may be positioned at suitable places to act as DRNs. That is nodes might dynamically switch roles. Such mobile DRNs can then change their position based on the dynamics of the system, to places where they currently would provide highest value.

Therefore, according to some embodiments herein, the network node 110 may control the communication devices that are mobile but temporarily not used to be positioned at suitable places and appoint them to be acting as dedicated relay nodes.

According to some embodiments herein, the relay node may be a dedicated communication device which is wall mounted in case of factory automation. In another embodiment, the relay-node may be carried by a drone in the case of fleet control. In the latter case, that drone may move to where it best serves the client device that have URC requirement and are in such positions that there is a risk that their radio channel becomes too poor.

Furthermore, it is possible to add a periodic ping or an application packet that carries the inertial measurement unit (IMU) information to the client device by the relay node.

In alternative embodiments there may be a master node in the wireless communication network 100 and the master node may assign itself as a relay node, in case where there is no communication device is willing to act as a relay node. Alternatively, the network node 110 may appoint a master node as a relay node.

In one embodiment, the network node 110 may setup a scoring or an incentive system to further motivate the communication devices 121, 122, 123 to restrict their movements and act as the relay for other communication devices. In this setup, the network node 110 may give score to those communication devices which restrict their movement and act as a relay node to facilitate the communication of other communication devices during a blockage period. The amount of score that the network node 110 gives to a communication device varies based on the time that the communication device acts as a relay node and the area that it covers when serving as a relay node. Later, the network node may prioritize and provide relaying nodes to a communication device based on its relaying score.

To summarize, according to embodiments herein, the network node appoints relay nodes dynamically to always maintain the communication link when the communication devices are moving into and out of the coverage region of the network node. In order to secure that a client communication device always has a coverage, the mobility and location of the communication device acting as a relay node for the client communication device may be controlled. That is the communication device acting as a relay node may position itself in a location, or temporarily restrict its further movements so that it can provide a sustained communication link to the communication device that needs sustained communication link. The communication device acting as a relay node thus may prioritize, at least temporarily, the relay function over its own normal communication device functionality. Further handover between relay nodes in the coverage region may be performed to secure ultra-reliable communication.

The embodiments herein provide a consolidating method handling dynamically appointed relay nodes as well as more permanently appointed relay nodes and dedicated relay nodes.

The embodiments herein minimize power and resource overhead for reliability enhancement using a limited number of relay nodes.

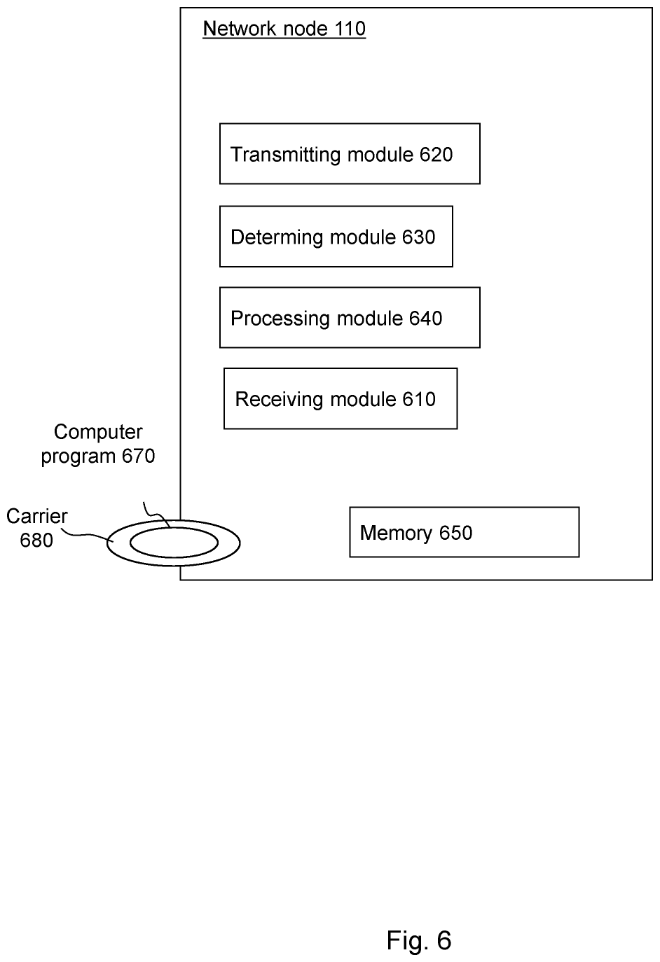

To perform the method in the network node 110 for communication in the wireless communication network 100 according to embodiment herein, the network node 110 comprises modules as shown in FIG. 6. The network node 110 comprises a receiving module 610, a transmitting module 620, a determining module 630, a processing module 640, a memory 650 etc. The network node 110 is configured to perform any one of the method actions 210-290 described above, for examples:

The network node 110 is configured to, e.g. by means of the determining module 630 being configured to, determine whether the communication with a second communication device 122 is to be relayed via a relay node and determine that the first communication device 121 is able to act as a relay node for the second communication device 122.

The network node 110 is configured to, e.g. by means of the transmitting module 620 being configured to, request the first communication device 121 to operate in a relay mode for relaying communications to the second communications device 122 if it is determined that the communication with the second communication device 122 is to be relayed via a relay node.

The network node 110 is configured to, e.g. by means of the transmitting module 620 and receiving module 610 being configured to, communicate with the second communication device 122 over a relay link from the network node 110 to the first communication device 121 and from the first communication device 121 to the second communication device 122.

Those skilled in the art will appreciate that the receiving module 610, the transmitting module 620, the determining module 630 and the processing module 630 described above in the network node 110 may be referred to one circuit or unit, a combination of analog and digital circuits, one or more processors, configured with software and/or firmware and/or any other digital hardware performing the function of each circuit/unit. One or more of these processors, the combination of analog and digital circuits as well as the other digital hardware, may be included in a single application-specific integrated circuitry (ASIC), or several processors and various analog/digital hardware may be distributed among several separate components, whether individually packaged or assembled into a system-on-a-chip (SoC).

The method according to embodiments herein may be implemented through one or more processors in the network node 110 together with computer program code for performing the functions and actions of the embodiments herein. The program code mentioned above may also be provided as a computer program product, for instance in the form of a data carrier 680 carrying computer program code 670, as shown in FIG. 5, for performing the embodiments herein when being loaded into the network node 110. One such carrier may be in the form of a CD ROM disc. It is however feasible with other data carriers such as a memory stick. The computer program code may furthermore be provided as pure program code on a server or a cloud and downloaded to the network node 110.

The memory 650 in the network node 110 may comprise one or more memory units and may be arranged to be used to store the group of candidate relay nodes, received information, report, measurements, data, configurations and applications to perform the method herein when being executed in the network node 110.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1.-21. (canceled)

22. A method performed in a network node configured to operate in a wireless communications network, wherein the network node is configured to communicate with a first communication device over a first communication link between the network node and the first communication device, and to communicate with a second communication device over a second communication link between the network node and the second communication device, wherein the method comprises:
determining whether communication with the second communication device is to be relayed via a relay node;
determining that the first communication device is able to act as a relay node for the second communication device;
when it is determined that communication with the second communication device is to be relayed via a relay node, requesting the first communication device to operate as a relay node for relaying communications to the second communication device;
communicating with the second communication device over a relay link from the network node to the first communication device and from the first communication device to the second communication device.

23. The method according to claim 22, wherein determining whether communication with the second communication device is to be relayed via a relay node comprises:
receiving a request from the second communication device indicating a requirement for communication link quality between the second communication device and the network node;
determining whether the quality of the second communication link meets or will meet the requirement for communication link quality; and
based on determining that the quality of the second communication link does not or will not meet the requirement for communication link quality, determining that the communication with the second communication device is to be relayed via a relay node.

24. The method according to claim 22, wherein determining whether communication with the second communication device is to be relayed via a relay node comprises:
receiving a request from the second communication device indicating that it has a declining battery level; and
based on the request, determining that the communication with the second communication device is to be relayed via a relay node.

25. The method according to claim 22, further comprising communicating with the second communication device over the second communication link in addition to over the relay link.

26. The method according to claim 22, wherein communicating with the second communication device over the relay link comprises sending most critical communications to the second communication device over the relay link.

27. The method according to claim 22, further comprising:
determining whether the quality of the second communication link meets a required threshold;
based on determining that the quality of the second communication link meets the required threshold, sending a request to the first communication device to release from operation as a relay node for the second communication device;
communicating with the second communication device over the second communication link instead of the relay link.

28. The method according to claim 22, wherein:
the method further comprises:
creating a group of candidate relay nodes comprising one or more communication devices which are in a coverage area of the network node and have capability and willingness to support relay node functionality; and
assessing prioritizations among the group of the candidate relay nodes; and
determining that the first communication device is able to act as a relay node for the second communication device comprises selecting the first communication device from the group of the candidate relay nodes based on the assessed prioritizations.

29. The method according to claim 28, wherein assessing prioritizations among the group of candidate relay nodes is based on one or more of the following characteristics of the communication devices that are in the group of candidate relay nodes:
communication channel qualities of the communication devices to the network node;
capabilities of the communication devices;
battery status of the communication devices;
ongoing communication activities of the communication devices;
projected movements of the communication devices;
time schedule slacks of the communication devices; and
serving time thresholds of the communication devices indicating during which they can serve as a relay node.

30. The method according to claim 28, wherein the capability and willingness of the respective communication devices to support relay node functionality is indicated when the respective communication devices sign up to Proximity Services (ProSe).

31. The method according to claim 28, further comprising determining whether a third communication device is needed as a relay node for the second communication device based on one or more of the following: a channel quality of the first communication link, and a trajectory of the first communication device.

32. The method according to claim 31, further comprising selecting the third communication device from the group of the candidate relay nodes based on the following:
recent channel quality indications of the candidate relay nodes, including the third communication device; and
the third communication device having a trajectory towards one or more radio shadow regions also in the trajectory of the first communication device.

33. The method according to claim 22, further comprising controlling the movement of the first communication device such that the first communication device is positioned where the quality of the relay link meets a required threshold.

34. The method according to claim 33, further comprising predicting at which positions the second communication device is likely to lose its connection to the network node, and controlling the movement of the first communication device based on the prediction.

35. The method according to claim 22, further comprising regulating the velocity of the first communication device to avoid entering an area where the communication channel quality to the network node does not or will not meet a required threshold.

36. The method according to claim 22, further comprising scheduling the first communication device so that relaying the communications of the second communication device is prioritized over the communications of the first communication device.

37. The method according to claim 22, wherein determining that the first communication device is able to act as a relay node for the second communication device comprises determining that the first communication device has been appointed as a dedicated relay node (DRN) in the wireless communication network.

38. The method according to claim 37, wherein one of the following applies:
the first communication device is at a fixed location; or
the first communication device is mobile but currently not being used, and the method further comprises controlling the movement of the first communication device such that the first communication device is positioned where the quality of the relay link meets a required threshold.

39. The method according to claim 22, wherein determining that the first communication device is able to act as a relay node for the second communication device comprises determining that the first communication device has been appointed as a master node that can operate as a relay node when no other communication device has capability and willingness to act as a relay node.

40. The method according to claim 22, wherein determining whether communication with the second communication device is to be relayed via a relay node is based on an incentive score of the second communication device, wherein the incentive score indicates a degree to which the second communication device restricted its movement and acted as a relay node for other communication devices during past blockage periods.

41. A network node configured to operate in a wireless communications network, wherein the network node is configured to communicate with a first communication device over a first communication link between the network node and the first communication device, and to communicate with a second communication device over a second communication link between the network node and the second communication device, wherein the network node comprises one or processors configured to execute computer program code that causes the network node to:
determine whether communication with the second communication device is to be relayed via a relay node;
determine that the first communication device is able to act as a relay node for the second communication device;
when it is determined that communication with the second communication device is to be relayed via a relay node, request the first communication device to operate as a relay node for relaying communications to the second communication device;
communicate with the second communication device over a relay link from the network node to the first communication device and from the first communication device to the second communication device.
